(19) United States
(12) Patent Application Publication
(10) Pub. No.: US 2010/0222976 A1
(43) Pub. Date: Sep. 2, 2010

(54) Driving assistance system having presence monitoring

(76) Inventor: Karsten Haug, Stuttgart (DE)

Correspondence Address: KENYON & KENYON LLP, ONE BROADWAY, NEW YORK, NY, 10004, US

(21) Appl. No.: 12/308,292

(22) PCT Filed: Oct. 1, 2007
(86) PCT No.: PCT/EP2007/060391

§ 371 Date: May 7, 2010

(30) Foreign Application Priority Data
Nov. 28, 2006 (DE) 10 2006 056 094.9

(51) Int. Cl. G06F 7/00; B60Q 1/00; B60T 7/12

(52) U.S. Cl. 701/70; 340/439

(57) ABSTRACT

A driver assistance system includes a control device, which has a self-deactivation function, and a monitoring device which is designed for monitoring the presence of the driver in the driver's seat and for triggering the self-deactivation function in the absence of the driver.

### BACKGROUND OF THE INVENTION

1. Field of the Invention

The present invention relates to a driver assistance system having a control device which has a self-deactivation function.

2. Description of Related Art

Examples of such driver assistance systems for motor vehicles include cruise control systems, so-called ACC (Adaptive Cruise Control) systems, which monitor the front area of the vehicle with the aid of a radar sensor and automatically regulate the distance to a preceding vehicle, as well as automatic lane-keeping systems and combinations of ACC and lane-keeping systems.

In the known ACC systems, the self-deactivation function is triggered, for example, when the radar sensor malfunctions or is blinded. The driver then receives an acoustic warning that the system is no longer available.

Assistance systems for motor vehicles, which are capable of detecting the driver dozing off and in this case automatically initiating controlled emergency braking of the vehicle to a standstill, are also known.

Furthermore, seat occupancy detectors in conjunction with having safety belt systems and/or airbag systems are known which detect, for example, the occupancy of the passenger seat by a person to enable the airbag system to be activated or a warning for buckling the seat belt to be output as a function of the detection signal.

### BRIEF SUMMARY OF THE INVENTION

An object of the present invention is to provide a driver assistance system having improved misuse protection.

This object is achieved according to the present invention by a monitoring device which is designed for monitoring the presence of the driver in the driver's seat and for triggering the self-deactivating function in the absence of the driver.

“Absence” of the driver may be understood here in general as a situation in which the driver is not assuming a posture appropriate for the driving situation with respect to the operating controls (for example, steering wheel and pedals).

In semi-autonomous driver assistance systems such as the above-mentioned ACC systems and lane-keeping systems and, mainly, in the case of a combination of these systems, there is the risk that the driver is tempted to take his hands off the steering wheel for a longer time and turn away from the traffic, to remove his feet far from the pedals or to leave the driver's seat completely or in part, for example, to pick up objects that fell down or, in the case of motor homes, to go to the back of the vehicle. Such a misuse of the semi-autonomous driver assistance systems which do not have the necessary functional safety for fully autonomous driving of the vehicle represents a considerable accident risk.

The present invention allows such a risky behavior of the driver to be detected and the driver to be forced to resume paying attention to the traffic environment.

The monitoring device may, for example, have a seat occupancy detector for the driver's seat which makes it possible to detect whether the driver is assuming his normal sitting position or has risen from the seat. Optionally a contact mat may also be provided in the backrest with the help of which it is detected whether the driver is leaning back against the backrest so that in risk situations he is able to immediately exert sufficient braking pressure on the brake pedal. Monitoring the safety belt length is also conceivable to determine whether the driver is leaning forward or to a side.

Alternatively or additionally, the monitoring device may also have a steering wheel sensor which allows detecting whether the driver has his hands on the steering wheel. This steering wheel sensor may be formed by a system of contact sensors or by a torque or force sensor which is capable of detecting the slight torques or forces which the driver knowingly or unknowingly exerts on the steering wheel or the steering column when he has his hands on the steering wheel. Since it is perfectly tolerable for the driver to take both his hands off the steering wheel for a few seconds, an absence of the driver is not detected by the steering wheel monitoring until the driver has released the steering wheel for a longer time period. Instead of or in addition to a steering wheel sensor, a passenger compartment monitoring system such as, for example, a passenger compartment camera having appropriate image analysis for detecting the arm position of the driver, may also be provided.

In addition, the position of the legs and feet may be monitored, so that their removal too far from the pedals may be detected. For this purpose, photoelectric barriers in the driver's feet area, contact floor mats, or inductive or capacitive sensors in the foot area, for example, may be situated so that a reliable detection of at least one foot or both feet no longer being near the pedals is made possible. The extremely risky way of driving in a cross-legged position, for example, may thus be detected.

When the monitoring device has determined an absence of the driver and this state persists for a certain time period, it is advantageous to first output a warning signal, preferably an acoustic warning signal which prompts the driver to reassume his normal sitting position in which he can reasonably respond to the traffic environment. The waiting time may be longer if the driver has only let go of the steering wheel and shorter if the driver has risen from his seat.

If the driver does not respond to the warning signal within a reasonable time, the self-deactivation function is triggered, preferably in conjunction with another subsequent warning in the form of a verbal message, which makes it clear to the driver that the assistance function is shutting down and he must again take over the control of the vehicle himself.

In a particularly useful specific embodiment, the self-deactivation function is configured such that it initiates a controlled emergency braking of the vehicle to a standstill if it is triggered by the monitoring device according to the present invention. The braking deceleration should be selected, as a function of whether or not an automatic lane-keeping system is active, in such a way that on the one hand the vehicle is brought to a standstill in a timely manner and, on the other hand, the traffic following behind is not exposed to risk. In any case, the self-deactivation function may also trigger an automatic turn-on of the warning light system of the vehicle.

When an automatic lane-keeping system is present, typically in conjunction with a video camera for detecting the lane markings on the roadway, the self-deactivation function may also be designed such that the vehicle is automatically steered onto the shoulder during emergency braking provided it is in the rightmost lane (in right-hand traffic).

If the vehicle is in a passing lane on a multi-lane roadway, which is usually detectable even with ACC systems without a lane-keeping function on the basis of location signals of the radar sensor, an emergency braking to a standstill may represent a problem from the point of view of safety. In this case, it may be more advantageous not to fully deactivate the driver assistance system, but only to limit the scope of its function, for example, in the form that the velocity of the vehicle is limited to a certain maximum velocity. The term “self-deactivation function” as used in this application also includes this functionality.

Even if the driver's seat is not left unoccupied, postures which do not correspond to the optimum driving position may be detected, for example, using the above-mentioned passenger compartment monitoring system. In these cases, the maximum setpoint velocity may be reduced by the ACC, since the braking force needed for this high velocity cannot be applied in this position. It is thus achieved that at high velocities the driver assumes a sitting posture in which he is optimally prepared to apply the brake.

The maximum settable setpoint velocity may also be reduced if the driver is intensely occupied by the controls, for example, is inputting a navigation destination, adjusting the seat, etc., since a vehicle should not be driven with high or maximum velocity if the driver's attentiveness is limited.

### BRIEF DESCRIPTION OF THE SEVERAL VIEWS OF THE DRAWINGS

FIG. 1 shows a block diagram of a driver assistance system according to the present invention.

FIG. 2 shows a flow chart for elucidating the mode of operation of the system.

### DETAILED DESCRIPTION OF THE INVENTION

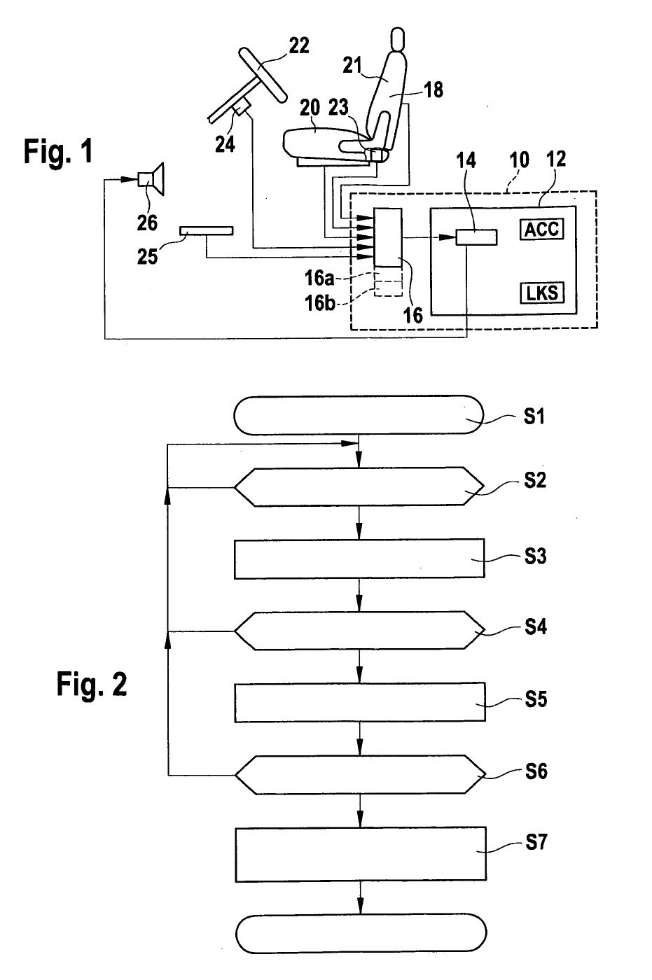

Driver assistance system 10 shown in FIG. 1 includes an electronic control device 12, which controls the assistance function or functions, in the example shown an ACC (adaptive Cruise Control) and a lane-keeping function LKS (Lane Keeping Support), and in which a self-deactivation function 14 is implemented, as well as a monitoring device 16 for monitoring the presence of the driver in a driver's seat 18.

A seat occupancy sensor 20 integrated into the seat cushion of driver's seat 18, which outputs a seat occupancy signal to monitoring device 16, and a contact sensor 21 integrated into the backrest of vehicle seat 18, which indicates whether the driver is leaning back on the backrest, are parts of monitoring device 16. In addition, FIG. 1 shows a seat belt retractor having an integrated seat belt length sensor 23 for measuring the extension length of the safety belt. In the example shown, a steering wheel sensor 24, which delivers an absence signal to monitoring device 16 if the driver has taken his hands off steering wheel 22 for a certain period of time, for example, a few seconds, and thus applies no force or torque to the steering wheel, is additionally provided on steering wheel 22 of the vehicle. Similarly, a foot area sensor 25 detects whether the driver is holding his feet in a ready-to-brake position.

Optionally, monitoring device 16 may also have a passenger compartment monitoring system 16a, which recognizes the sitting posture of the driver, and an interface 16b for other operating devices of the vehicle. Using this interface it is possible to recognize whether the attention of the driver is being distracted by the operation of some controls such as those on the navigation system, so that such situations may be responded to by limiting the setpoint velocity of the vehicle, for example.

A speaker 26, via which acoustic warnings, for example voice messages prompted by self-deactivation function 14, may be output, is connected to control device 12.

FIG. 2 is a flow chart which illustrates the mode of operation of monitoring device 16 and self-deactivation function 14. The flow chart represents a program routine which is started by activating driver assistance system 10 at step S1 and is then run through cyclically during the entire duration of the activity of the driver assistance system.

In step S2, monitoring device 16 checks, on the basis of the signals of seat occupancy sensor 20, steering wheel sensor 24, and foot area sensor 25, whether the driver is in driver's seat 18 and has his hands on the steering wheel and his feet near the pedals or whether he is “absent,” which here means that the driver does not weigh on the driver's seat with a substantial portion of his weight and/or his hands are completely off the steering wheel for a certain period of time, and/or he has assumed a foot position in which his response readiness is reduced. If the driver is assuming his normal sitting position and thus is ready and able to respond to unforeseen traffic events in a timely manner (N in step S2), the program jumps back to step S2. However, if the driver is absent in the sense explained above (Y), in step S3 a waiting period of a few seconds, for example, is initiated. During this waiting period, the signals of seat occupancy sensor 20, steering wheel sensor 24, and foot area sensor 25 continue to be monitored. If the driver's absence is established again, a jump back to step S2 takes place via step S4. However, if, after the waiting time in step S4 has elapsed, the driver is still absent, in step S5 a warning signal is output via speaker 26 and another waiting period is started to see whether the driver will assume his normal sitting position.

If the driver assumes his normal sitting position again within this waiting period, in step S6 a jump back to step S2 takes place. Otherwise, in step S7 the driver is given another subsequent acoustic prompt that the assistance functions will be now shut off and self-deactivation function 14 triggers a transition of the vehicle into a fail-safe state, for example, a controlled emergency braking of the vehicle to a standstill. At a standstill of the vehicle, driver assistance system 10 is deactivated, so that the driver must assume the controls himself in order to get the vehicle moving again.

1-16. (canceled)

17. A driver assistance system for a vehicle, comprising:
a control device having a self-deactivation function; and
a monitoring device configured to monitor at least one of a presence of a driver and a posture of a driver in a driver's seat;
wherein the self-deactivation function is triggered if a triggering conditions is satisfied, wherein the triggering condition includes one of (a) the presence of the driver in the driver's seat is not detected, or (b) the posture of the driver in the driver seat is determined to deviate from a reference posture for normal driving operation.

18. The driver assistance system as recited in claim 17, wherein the monitoring device includes a seat occupancy sensor in the seat bottom of the driver's seat.

19. The driver assistance system as recited in claim 18, wherein the monitoring device includes a contact sensor in the backrest of the driver's seat.

20. The driver assistance system as recited in claim 18, wherein the monitoring device includes a steering wheel sensor configured to recognize a state in which hands of the driver are not in contact with the steering wheel of the vehicle for an uninterrupted predefined time period.

21. The driver assistance system as recited in claim 18, wherein the monitoring device includes a foot area sensor configured to recognize a state in which feet of the driver are held in a position for an uninterrupted predefined time period in which immediate pedal operation is impossible.

22. The driver assistance system as recited in claim 18, wherein the monitoring device includes a passenger compartment monitoring system configured to monitor the posture of the driver.

23. The driver assistance system as recited in claim 18, wherein the monitoring device includes a seat-belt length sensor configured to monitor the extension length of a safety belt of the driver's seat.

24. The driver assistance system as recited in claim 18, wherein the monitoring device includes an interface for interaction with selected operating devices of the vehicle, and wherein the interface enables determination of whether the driver is engaged in operation of a control for at least one of the selected operating devices.

25. The driver assistance system as recited in claim 18, wherein, upon detection of the triggering condition being satisfied, the self-deactivation function (a) initially causes a warning to be output to the driver after a predefined waiting period has elapsed, and (b) if the triggering condition continues to be satisfied, at least partially deactivating selected functions of the driver assistance system after another predefined waiting period has elapsed.

26. The driver assistance system as recited in claim 25, wherein the self-deactivation function outputs another warning to the driver after the selected functions of the driver assistance functions are at least partially deactivated.

27. The driver assistance system as recited in claim 18, wherein the self-deactivation function triggers a controlled emergency braking of the vehicle.

28. The driver assistance system as recited in claim 27, wherein the self-deactivation function (a) controls braking of the vehicle to a standstill, and (b) at least partially deactivates the selected driver assistance functions only after the vehicle has reached full stand-still condition.

29. The driver assistance system as recited in claim 18, wherein the control device has an assistance function for regulating the velocity of the vehicle.

30. The driver assistance system as recited in claim 29, wherein the assistance function regulates the distance of the vehicle to a preceding vehicle.

31. The driver assistance system as recited in claim 29, wherein the self-deactivation function provides at least one of (a) an upper limit of a setpoint velocity of the vehicle, and (b) a lower limit of a target distance to the preceding vehicle.

32. The driver assistance system as recited in claim 29, wherein the control device has an automatic lane-keeping function.
